(19) United States
(12) Patent Application Publication
(10) Pub. No.: US 2010/0046381 A1
(43) Pub. Date: Feb. 25, 2010

(54) METHOD AND APPARATUS FOR PROCESSING OF AN ALARM RELATED TO A FRAME RELAY ENCAPSULATION FAILURE

(76) Inventors: Paritosh Bajpay, Edison, NJ (US); Mojgan Dardashti, Holmdel, NJ (US); Zhiqiang Qian, Holmdel, NJ (US); Michael John Zinnikas, North Brunswick, NJ (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/196,929

(22) Filed: Aug. 22, 2008

(51) Int. Cl. H04L 12/26

(52) U.S. Cl. 370/244

(57) ABSTRACT

A method and apparatus for providing automated processing of an alarm related to a frame relay encapsulation failure on a packet network, e.g., a Virtual Private Network (VPN), are disclosed. For example, the method receives an alarm or a ticket related to a network connection with a frame relay encapsulation, and correlates the ticket or said alarm with a circuit. The method determines a number of logical channels supported by the circuit between a customer edge (CE) router and a provider edge (PE) router. The method performs one or more tests from the PE router to one or more customer end device connected to the PE router through the CE router, and performs one or more tests from the PE router to one or more remote customer end devices, if all of the one or more tests from the PE router to the one or more customer end devices connected to the PE router through the CE router are successful.

The present invention relates generally to communication networks and, more particularly, to a method and apparatus for providing automated processing of an alarm related to a frame relay encapsulation failure on a packet network, e.g., a Virtual Private Network (VPN).

### BACKGROUND OF THE INVENTION

An enterprise customer may build a Virtual Private Network (VPN) by connecting multiple sites or users over a network from a telephony service provider. When a service failure or degradation occurs, it may be detected by the network service provider or reported by a customer to the network service provider. For example, if a frame relay encapsulation failure occurs on an access circuit shared by multiple frame relay logical channels, the enterprise customer may lose all or part of his/her network connections. The network service provider may then dispatch maintenance personnel to perform trouble isolation and repair(s). However, in a large network, the cost of dispatching personnel for each detected and/or reported problem is very expensive. In addition, the customer may be receiving a degraded service or no service at all while manual diagnosis is being performed. The degraded service and the delay in performing maintenance may affect customer satisfaction and may also be detrimental to the enterprise customer's business.

### SUMMARY OF THE INVENTION

In one embodiment, the present invention discloses a method and apparatus for providing automatic processing of an alarm related to frame relay encapsulation failure on a packet network, e.g., a Virtual Private Network (VPN). For example, the method receives an alarm or a ticket related to a network connection with a frame relay encapsulation, and correlates the ticket or said alarm with a circuit. The method determines a number of logical channels supported by the circuit between a customer edge (CE) router and a provider edge (PE) router. The method performs one or more tests from the PE router to one or more customer end device connected to the PE router through the CE router, and performs one or more tests from the PE router to one or more remote customer end devices, if all of the one or more tests from the PE router to the one or more customer end devices connected to the PE router through the CE router are successful.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network with automated processing of an alarm related to a frame relay encapsulation failure;

FIG. 3 illustrates a flowchart of a method for providing automated processing of an alarm related to a frame relay encapsulation failure; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing automated processing of an alarm related to a frame relay encapsulation failure on a packet network, e.g., a Virtual Private Network (VPN). Although the present invention is discussed below in the context of virtual private networks, the present invention is not so limited. Namely, the present invention can be applied for other networks with multiple logical frame relay channels sharing a physical circuit.

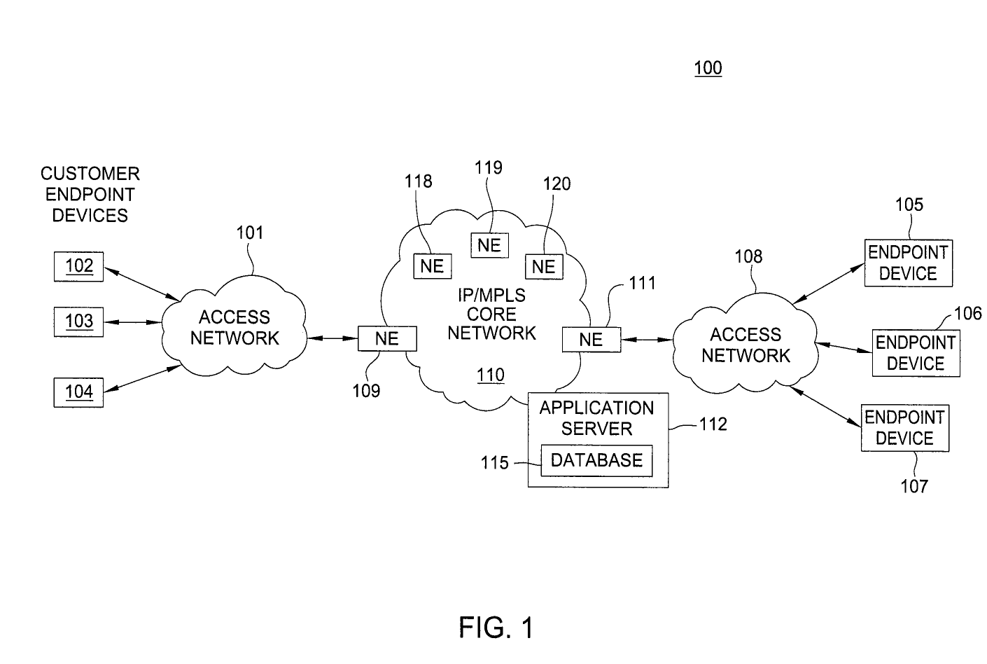

FIG. 1 is a block diagram depicting an exemplary packet network 100 related to the current invention. Exemplary packet networks include Internet protocol (IP) networks, Ethernet networks, and the like. An IP network is broadly defined as a network that uses Internet Protocol such as IPv4 or IPv6 and the like to exchange data packets.

In one embodiment, the packet network may comprise a plurality of endpoint devices 102-104 configured for communication with the core packet network 110 (e.g., an IP based core backbone network supported by a service provider) via an access network 101. Similarly, a plurality of endpoint devices 105-107 are configured for communication with the core packet network 110 via an access network 108. The network elements 109 and 111 may serve as gateway servers or edge routers for the network 110.

The endpoint devices 102-107 may comprise customer endpoint devices such as personal computers, laptop computers, Personal Digital Assistants (PDAs), servers, routers, and the like. The access networks 101 and 108 serve as a means to establish a connection between the endpoint devices 102-107 and the NEs 109 and 111 of the IP/MPLS core network 110. The access networks 101 and 108 may each comprise a Digital Subscriber Line (DSL) network, a broadband cable access network, a Local Area Network (LAN), a Wireless Access Network (WAN), a 3^{rd} party network, and the like. The access networks 101 and 108 may be either directly connected to NEs 109 and 111 of the IP/MPLS core network 110, or indirectly through another network.

Some NEs (e.g., NEs 109 and 111) reside at the edge of the core infrastructure and interface with customer endpoints over various types of access networks. An NE that resides at the edge of a core infrastructure is typically implemented as an edge router, a media gateway, a border element, a firewall, a switch, and the like. An NE may also reside within the network (e.g., NEs 118-120) and may be used as a mail server, honeypot, a router, or like device. The IP/MPLS core network 110 also comprises an application server 112 that contains a database 115. The application server 112 may comprise any server or computer that is well known in the art, and the database 115 may be any type of electronic collection of data that is also well known in the art. Those skilled in the art will realize that although only six endpoint devices, two access networks, five network elements, one application server are depicted in FIG. 1, the communication system 100 may be expanded by including any number of endpoint devices, access networks, network elements, application servers and the like without altering the scope of the present invention.

The above IP network is described to provide an illustrative environment in which packets for voice and data services are transmitted on networks. An enterprise customer may build a Virtual Private Network (VPN) by connecting multiple sites or users over a network from a telephony service provider. When a network service is either degraded or failed, the service trouble may be detected by the network service provider or reported by a customer to the network service provider. For example, a customer may report a connection trouble for a VPN service with frame relay encapsulation. The network service provider may then dispatch maintenance personnel to perform trouble isolation and repair. However, in a large network, the cost of dispatching personnel for each detected and/or reported problem is very expensive. In addition, the customer may be receiving a degraded service or no service for all or part of the VPN while alarms are being collected, analyzed, etc. for trouble isolation and repair.

In one embodiment, the present invention discloses a method and apparatus for providing automatic processing of an alarm related to a frame relay encapsulation failure on a packet network, e.g., a Virtual Private Network (VPN). In order to clearly describe the current invention, the following networking terminology are first provided:

A Virtual Private Network (VPN); and

Frame Relay (FR) encapsulation.

A Virtual Private Network (VPN) refers to a network in which a set of customer locations communicate over a provider's network or the Internet in a private manner. The set of customer locations that may communicate with each other over the VPN are configured when the VPN is setup. That is, locations outside of the VPN are not allowed to intercept packets from the VPN or send packets over the VPN. Each VPN site has one or more Customer Edge (CE) routers in communication with one or more Provider Edge (PE) routers. Each PE router in communication with a CE router maintains a Virtual Route Forwarding (VRF) table for the VPN and forwards traffic among various VPN sites using the VRF table. Since there is a physical connection between the PE router and the CE router for each VPN site, no authentication is used among VPN sites. Note that, the physical connection may be over another access network, or directly between the CE router at a VPN site and the PE router.

Frame Relay (FR) encapsulation refers to a multi link frame relay service that enables sharing one physical circuit by multiple logical channels. For example, a T1 channel has a data rate of 1.544 Mbps and it may carry 24 Layer-3 logical channels each at 64 Kbps.

When a customer subscribes to a VPN service with frame relay encapsulation, the service provider configures the VPN and connects each CE router to a PE router over a physical circuit that may be shared by multiple logical channels. That is, the connection between the PE router and CE router may be shared by various customer end devices (e.g., computers, servers, etc.) attached to the CE router. If a frame relay encapsulation failure occurs, a customer, e.g., a VPN customer, may lose all or part of the customer network connections. The current invention provides a method for automated processing of a network alarm related to a frame relay encapsulation failure.

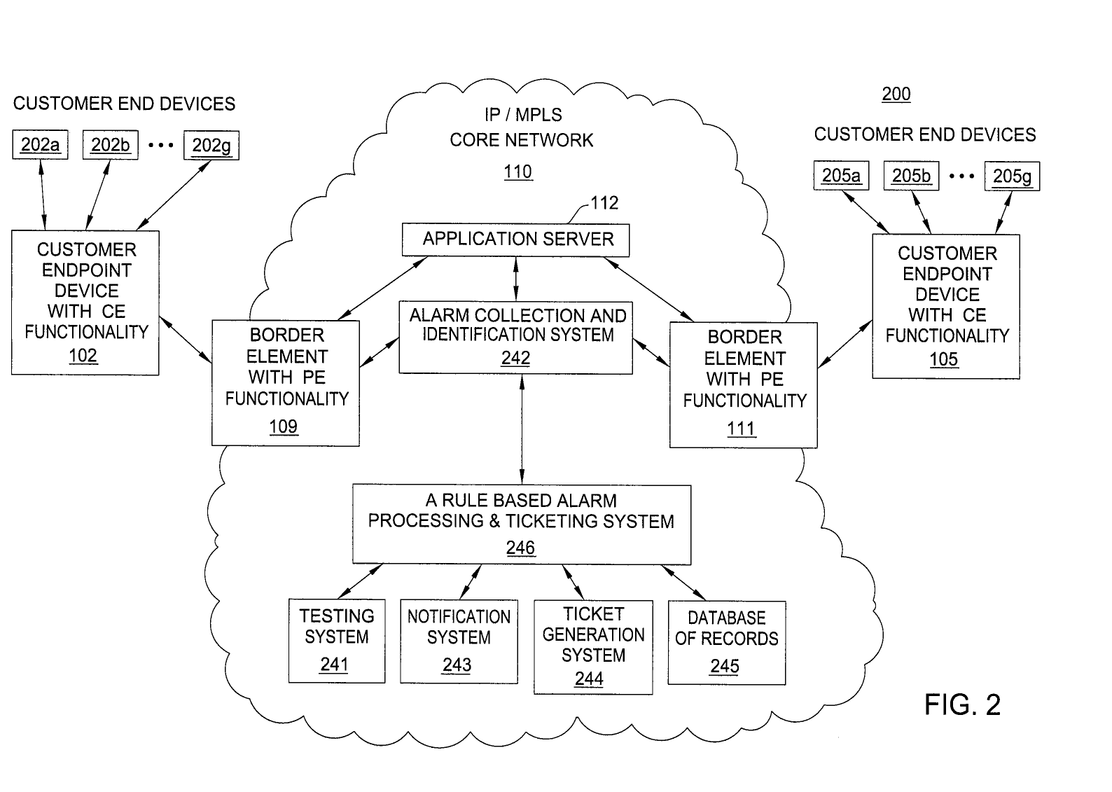

FIG. 2 provides an illustrative network 200 with automated processing of an alarm related to a frame relay encapsulation failure. For example, customer endpoint devices 102 and 105 may function as CE routers for a VPN connecting two customer locations over an IP/MPLS core network 110. Customer end devices 202a-202g are connected to CE router 102 for accessing VPN services over the IP/MPLS core network 110. Similarly, customer end devices 205a-205g are connected to CE router 105 for accessing VPN services over the IP/MPLS core network 110. The IP/MPLS core network 110 may comprise an application server 112, border elements 109 and 111, a testing system 241, an alarm collection and identification system 242, a notification system 243, a ticket generation system 244, a database of records 245, and a rule based alarm processing and ticketing system 246.

In one embodiment, border elements 109 and 111 function as PE routers for the IP/MPLS core network 110. The rule based alarm processing and ticketing system 246 is connected to the various systems 241-245 for automating the processing of network alarms. The application server 112 enables customers to subscribe to services with automated processing of network alarms, e.g., VPN services with automated processing of frame relay encapsulation alarms.

In one embodiment, the testing system 241 is used for sending test packets and receiving responses. For example, the testing system may send “ping” signals to ports on switches or routers, obtain snapshots of various counters in routers and switches, and so on. The ticket generation system 244 is accessible by customers and service provider personnel for generating a ticket. For example, a customer or work center personnel may interact with an Interactive Voice Response (IVR) system and generate a ticket. The ticket may also be created from automatically detected alarms by alarm collection and identification system 242. The alarm collection and identification system 242 is connected to the routers in IP/MPLS core network 110, e.g., PE routers 109 and 111. Similarly, the notification system 243 may be used to provide a notification to a customer, or one or more work centers.

The customer endpoint device with CE router functionality 102 is connected to the border element with PE router functionality 109. The customer endpoint device with CE router functionality 105 is connected to the border element with PE router functionality 111. Traffic from CE router 102 travels towards CE router 105 via PE router 109, IP/MPLS core network 110 and PE router 111. Traffic from CE router 105 travels towards CE router 102 via PE router 111, IP/MPLS core network 110 and PE router 109.

In one embodiment, the current invention provides automatic processing of alarms related to a frame relay encapsulation failure by first gathering alarms and tickets related to connections with frame relay encapsulation, e.g., connections for VPN services with frame relay encapsulation. In one example, a customer interacts with a ticket generation system 244 and generates a ticket for a loss of one or more connections for a VPN service with frame relay encapsulation.

The rule based alarm processing and ticketing system 246 may then correlate the ticket or alarm with circuit data. For the example above, the rule based alarm processing and ticketing system may access a database of record 245, and retrieve circuit data, e.g., frame relay data, port number, switch or router identification, etc. for the customer connection related to the received ticket or alarm. The rule based alarm processing and ticketing system 246 may then use the retrieved circuit data to determine whether or not there are network outages that may affect the circuit. In one example, there may be a Layer 1 network outage that may cause the customer connection(s) to fail. The method may then use the circuit data to identify Layer 1 ports used by the circuit, determine the status of each of said Layer 1 ports, and determine whether or not one or more of said Layer 1 ports are down. If there is a Layer 1 network outage, the failure on the customer connection may be caused by the Layer 1 network outage. If no network outage exists, the current invention may then proceed to process the ticket or alarm to diagnose one or more possible frame relay encapsulation failures.

In one embodiment, the method first determines the number of logical channels the physical circuit between the CE and PE routers supports. For example, a customer may have up to 24 logical channels (e.g., for up to 24 customer end devices) sharing a T1 physical circuit between the CE and PE routers. The method may then determine the status of each of the logical channels. For example, the method may take a snapshot of Layer 3 ports to determine whether or not the ports are active.

If all the ports for the logical channels are active, the method may then initiate tests from the PE router to each of the customer end devices connected to it through the CE router. For the example in FIG. 2, tests such as ping signals may be initiated from PE router 109 to each of the customer end devices 202a-202g. It should be noted that in this step, tests from the PE router are directed to the end points at the local site. For example, the tests are sent to customer end devices 202a-202g, but not to customer end devices 205a-205g. If a test fails, the method may then diagnose the problem and notify the appropriate work center. For example, the method may identify configuration error, IP-address trouble, etc.

If all the tests from the PE router to each of the customer end point devices connected to it through the CE router are successful, the method may initiate tests from the PE router to remote customer end devices. For example, ping signals may be initiated from PE router 109 to each of the customer end devices 205a-205g. If all tests from the PE router to the remote customer end devices are successful, the method may notify the customer of successful test results. If one or more tests fail, the method may then diagnose the problem and notify the appropriate work center.

In one embodiment, the service provider may not know the IP addresses of the remote customer end devices and therefore may interact with the customer to retrieve the IP addresses of the remote customer end devices, prior to initiating tests. For example, the customer may not have provided the IP addresses of customer end devices 205a-205g to the service provider when the ticket is opened.

In one embodiment, the service provider may wish to reduce the number of logical channels to be tested. For example, if a configuration error occurs it may be detected by testing a small percentage of the logical channels supported by a physical channel. In one embodiment, the current method selects a portion of the logical channels and determines the status of the ports for the selected logical channels. For example, the method may select 5 logical channels out of 24 logical channels and take snapshots of the Layer 3 ports for the 5 selected logical channels.

In one embodiment, the number of logical channels that may be selected for determination of port status is configurable. For example, the network service provider may determine the number of logical channels that may be selected. In another embodiment, the customer specifies the number of logical channels that may be selected for determination of port status. For example, a customer may prefer the service provider to check port status for all logical circuits prior to a more details diagnosis.

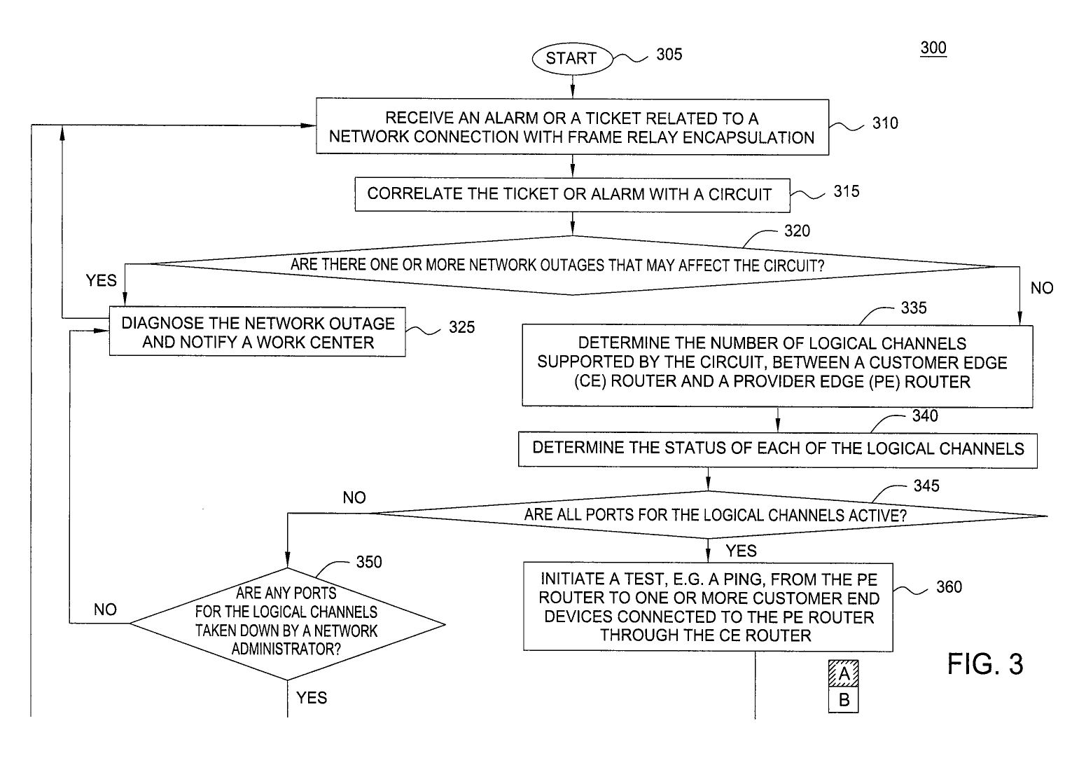

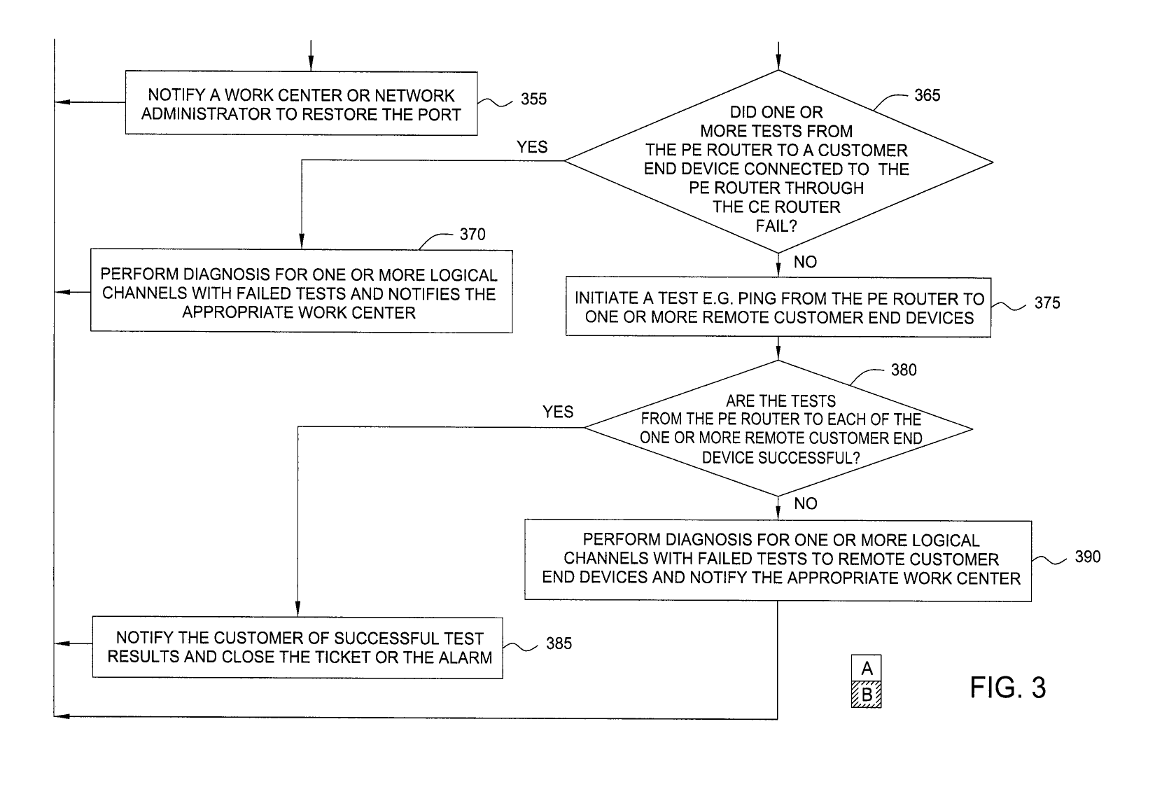

FIG. 3 illustrates a flowchart of a method 300 for providing automatic processing of an alarm related to a frame relay encapsulation failure. For example, one or more steps of method 300 can be implemented by the rule based alarm processing and ticketing system. Method 300 starts in step 305 and proceeds to step 310.

In step 310, method 300 receives an alarm or a ticket related to a network connection with frame relay encapsulation, e.g., connections for VPN services with frame relay encapsulation.

In step 315, method 300 correlates the ticket or alarm with a circuit. For example, the method may access a database of record and identify circuit identification, e.g., frame relay data, port number, switch or router identification, etc. for the customer connection related to the received ticket or alarm.

In step 320, method 300 determines whether or not there are one or more network outages that may affect the circuit. In one example, there may be a Layer 1 network outage that may cause the customer connection(s) to fail. For example, the method may use the circuit data to identify Layer 1 ports used by the circuit, and then determine whether or not there are network outages that may affect each of the Layer 1 ports. For example, the method may determine if one or more of the Layer 1 ports are down. If there is at least one network outage that may affect the circuit, the method proceeds to step 325. Otherwise the method proceeds to step 335.

In step 325, method 300 diagnoses the network outage and notifies a work center. For example, the method may determine whether or not the circuit is a domestic circuit or an international circuit; whether or not the trouble is on a Layer 1 or Layer 2 network; and then notify the appropriate work center. The method then proceeds to step 310 to continue receiving alarms or tickets.

In step 335, method 300 determines the number of logical channels supported by the circuit, between a Customer Edge (CE) router and a Provider Edge (PE) router. For example, a customer may have up to 24 logical channels (e.g., for up to 24 customer end devices) sharing a T1 circuit between the CE and PE routers.

In step 340, method 300 determines the status of each of the logical channels. For example, the method may take a snapshot of Layer 3 ports on customer end devices to determine whether or not the ports are active.

In step 345, method 300 determines whether or not all the ports for the logical channels are active. If all the ports for the logical channels are active, the method proceeds to step 360. Otherwise, the method proceeds to step 350.

In step 350, method 300 determines whether or not any ports for the logical channels are taken down by a network administrator. For example, the status of the port may indicate “admin down.” If a port is taken down by an administrator, the method proceeds to step 355. Otherwise, the method proceeds to step 325 to diagnose the network outage and notify a work center.

In step 355, method 300 notifies a work center or network administrator to restore the port. For example, a work center may be notified to remove the “admin down” for a port. The method then proceeds to step 310 to continue receiving alarms or tickets.

In step 360, method 300 initiates a test, e.g., sending a ping signal, from the PE router to one or more customer end devices connected to the PE router through the CE router.

In step 365, method 300 determines whether or not one or more tests from the PE router to a customer end device connected to the PE router through the CE router have failed. If a test failed, the method proceeds to step 370. Otherwise, the method proceeds to step 375.

In step 370, method 300 performs diagnosis for one or more logical channels with failed tests and notifies the appropriate work center. For example, the method may identify configuration error, IP-address trouble, etc. for customer end devices connected to the PE router through the local CE router and notifies a work center of the relevant trouble. The method then proceeds to step 310 to continue receiving alarms or tickets.

In step 375, method 300 initiates a test, e.g., sending a ping signal, from the PE router to one or more remote customer end device. For example, ping tests may be initiated to other VPN sites.

In step 380, method 300 determines whether or not all tests from the PE router to each of the one or more remote customer end device are successful. If all the tests from the PE router to each remote customer end device are successful, the method proceeds to step 385. Otherwise, the method proceeds to step 390.

In step 385, method 300 notifies the customer of successful test results and closes the ticket or alarm. The method then proceeds to step 310 to continue receiving alarms or tickets.

In step 390, method 300 performs diagnosis for one or more logical channels with failed tests to remote customer end devices and notifies the appropriate work center. For example, the method may identify a configuration error, IP-address trouble, etc. and then notify a work center of the relevant trouble and diagnosis at the remote site. The method then proceeds to step 310 to continue receiving alarms or tickets.

It should be noted that although not specifically specified, one or more steps of method 300 may include a storing, displaying and/or outputting step as required for a particular application. In other words, any data, records, fields, and/or intermediate results discussed in the method 300 can be stored, displayed and/or outputted to another device as required for a particular application. Furthermore, steps or blocks in FIG. 3 that recite a determining operation, or involve a decision, do not necessarily require that both branches of the determining operation be practiced. In other words, one of the branches of the determining operation can be deemed as an optional step.

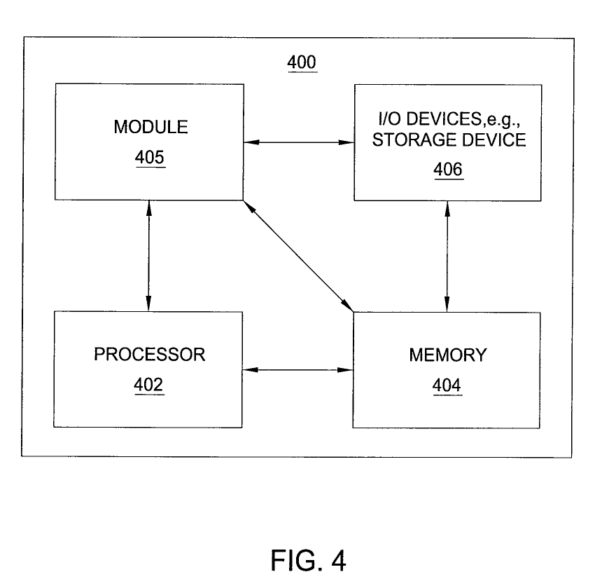

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing automatic processing of an alarm related to a frame relay encapsulation failure, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for providing automatic processing of an alarm related to a frame relay encapsulation failure can be loaded into memory 404 and executed by processor 402 to implement the functions as discussed above. As such, the present method 405 for providing automatic processing of an alarm related to a frame relay encapsulation failure (including associated data structures) of the present invention can be stored on a computer readable medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for processing an alarm, comprising:
receiving an alarm or a ticket related to a network connection with a frame relay encapsulation;
correlating said ticket or said alarm with a circuit;
determining a number of logical channels supported by said circuit between a customer edge (CE) router and a provider edge (PE) router;
performing one or more tests from said PE router to one or more customer end device connected to said PE router through said CE router; and
performing one or more tests from said PE router to one or more remote customer end devices, if all of said one or more tests from said PE router to said one or more customer end devices connected to said PE router through the CE router are successful.

2. The method of claim 1, further comprising:
performing a diagnosis for one or more logical channels with a failed test result.

3. The method of claim 1, further comprising:
notifying a customer or a work center of one or more results from performing said one or more tests from said PE router to said one or more customer end device.

4. The method of claim 1, further comprising:
notifying a customer or a work center of one or more results from performing said one or more tests from said PE router to said one or more remote customer end devices.

5. The method of claim 1, wherein an Internet Protocol (IP) address for each of said one or more remote customer end devices is received from a customer prior to performing said one or more tests to said one or more remote customer end devices.

6. The method of claim 1, wherein only a portion of said number of logical channels is selected for performing said one or more tests.

7. The method of claim 6, wherein said portion of said number of logical channels is configurable by a network service provider or a customer.

8. A computer-readable medium having stored thereon a plurality of instructions, the plurality of instructions including instructions which, when executed by a processor, cause the processor to perform the steps of a method for processing an alarm, comprising:
receiving an alarm or a ticket related to a network connection with a frame relay encapsulation;
correlating said ticket or said alarm with a circuit;
determining a number of logical channels supported by said circuit between a customer edge (CE) router and a provider edge (PE) router;
performing one or more tests from said PE router to one or more customer end device connected to said PE router through said CE router; and
performing one or more tests from said PE router to one or more remote customer end devices, if all of said one or more tests from said PE router to said one or more customer end devices connected to said PE router through the CE router are successful.

9. The computer-readable medium of claim 8, further comprising:
performing a diagnosis for one or more logical channels with a failed test result.

10. The computer-readable medium of claim 8, further comprising:
notifying a customer or a work center of one or more results from performing said one or more tests from said PE router to said one or more customer end device.

11. The computer-readable medium of claim 8, further comprising:
notifying a customer or a work center of one or more results from performing said one or more tests from said PE router to said one or more remote customer end devices.

12. The computer-readable medium of claim 8, wherein an Internet Protocol (IP) address for each of said one or more remote customer end devices is received from a customer prior to performing said one or more tests to said one or more remote customer end devices.

13. The computer-readable medium of claim 8, wherein only a portion of said number of logical channels is selected for performing said one or more tests.

14. The computer-readable medium of claim 13, wherein said portion of said number of logical channels is configurable by a network service provider or a customer.

15. An apparatus for processing an alarm, comprising:
means for receiving an alarm or a ticket related to a network connection with a frame relay encapsulation;
means for correlating said ticket or said alarm with a circuit;
means for determining a number of logical channels supported by said circuit between a customer edge (CE) router and a provider edge (PE) router;
means for performing one or more tests from said PE router to one or more customer end device connected to said PE router through said CE router; and
means for performing one or more tests from said PE router to one or more remote customer end devices, if all of said one or more tests from said PE router to said one or more customer end devices connected to said PE router through the CE router are successful.

16. The apparatus of claim 15, further comprising:
means for performing a diagnosis for one or more logical channels with a failed test result.

17. The apparatus of claim 15, further comprising:
means for notifying a customer or a work center of one or more results from performing said one or more tests from said PE router to said one or more customer end device.

18. The apparatus of claim 15, further comprising:
notifying a customer or a work center of one or more results from performing said one or more tests from said PE router to said one or more remote customer end devices.

19. The apparatus of claim 15, wherein an Internet Protocol (IP) address for each of said one or more remote customer end devices is received from a customer prior to performing said one or more tests to said one or more remote customer end devices.

20. The apparatus of claim 15, wherein only a portion of said number of logical channels is selected for performing said one or more tests.
